(19) United States
(12) Patent Application Publication
(10) Pub. No.: US 2024/0186907 A1
(43) Pub. Date: Jun. 6, 2024

(54) POWER CONVERTER

(71) Applicant: PANASONIC HOLDINGS CORPORATION, Osaka (JP)

(72) Inventors: Hongan SHIH, Kyoto (JP); Kenichiro TANAKA, Hyogo (JP); Shinji UJITA, Osaka (JP); Ryo KAJITANI, Osaka (JP)

(21) Appl. No.: 18/549,292

(22) PCT Filed: Mar. 2, 2022
(86) PCT No.: PCT/JP2022/008842

§ 371 Date: Sep. 6, 2023

(30) Foreign Application Priority Data
Mar. 12, 2021 (JP) 2021-040837

(51) Int. Cl. H02M 3/335; B60L 53/16; H02J 7/00; H02M 3/00

(52) U.S. Cl. CPC H02M 3/33584; B60L 53/16; H02M 3/01; B60L 2210/10; B60L 2210/30; H02J 7/007; H02J 2207/20

(57) ABSTRACT

A power converter includes an insulated DC conversion unit that is configured to bidirectionally convert a first DC voltage and a second DC voltage that is lower than the first DC voltage. The DC conversion unit is configured to selectively perform a first operation, a second operation, and a third operation. In the first operation, the first DC voltage is converted into the second DC voltage. In the second operation, the second DC voltage is converted into the first DC voltage. In the third operation, a third DC voltage that is equal to lower than the second DC voltage is converted into a fourth voltage that is lower than the third DC voltage.

### TECHNICAL FIELD

The present disclosure relates to a power converter. In particular, the present disclosure relates to a power converter that is installed in an electric car or hybrid electric car to charge a main battery and an auxiliary battery.

### BACKGROUND ART

As a conventional technique, a vehicle power supply unit (power converter) recited in Patent Literature 1 will be illustrated. The vehicle power supply unit recited in Patent Literature 1 (hereinafter, referred to as a “conventional technique”) includes a power conversion unit and a constant voltage DC/DC conversion unit.

The power conversion unit includes an AC/DC conversion unit and a step-down DC/DC conversion unit. The AC/DC conversion unit converts AC power supplied from an AC source into DC power, and charges a high-voltage battery with the DC power. The step-down DC/DC conversion unit steps down the DC power supplied from the high-voltage battery to generate an intermediate voltage.

The constant voltage DC/DC conversion unit steps down, at a constant step-down ratio, the intermediate voltage of the DC power that has been outputted from the step-down DC/DC conversion unit and then outputs the stepped-down intermediate voltage to a low-voltage load unit.

In the conventional technique, the above-mentioned configuration aims at reducing the chances of the vehicle power supply unit coming to have an increased size.

In the conventional technique, however, the constant voltage DC/DC conversion unit is composed of a non-insulated buck converter. Therefore, if trouble occurs in the constant voltage DC/DC conversion unit, a relatively high intermediate voltage could be applied to the low-voltage load unit, thereby decreasing safety of the vehicle power supply unit.

### CITATION LIST

### Patent Literature

Patent Literature 1: JP2020-43729 A

### SUMMARY OF INVENTION

It is therefore an object of the present disclosure to provide a power converter configured to have a reduced overall size and enhanced safety.

A power converter according to one aspect of the present disclosure includes an insulated DC conversion unit that is configured to bidirectionally convert a first DC voltage into a second DC voltage that is lower than the first DC voltage and vise versa. The DC conversion unit is configured to selectively perform a first operation, a second operation, and a third operation. The first operation converts the first DC voltage into the second DC voltage. The second operation converts the second DC voltage into the first DC voltage. The third operation converts a third DC voltage that is equal to or lower than the second DC voltage into a fourth voltage that is lower than the third DC voltage.

### BRIEF DESCRIPTION OF DRAWINGS

FIG. 1 is a block diagram of a power converter according to an embodiment of the present disclosure.

FIG. 2 is a circuit configuration diagram of a first DC conversion unit of the power converter.

FIG. 3 is a circuit configuration diagram of a second DC conversion unit of the power converter.

FIG. 4 is a circuit configuration diagram of an AC-DC conversion unit of the power converter.

FIG. 5 is a configuration diagram of a switching unit of the power converter.

### DESCRIPTION OF EMBODIMENTS

A power converter according to an embodiment of the present disclosure will be described in detail with reference to the accompanying drawings. Note that the configurations to be described in the embodiments are only an example of the present disclosure and should not be construed as limiting. Rather, numerous modifications or variations can be readily made by those skilled in the art depending on their design choice or any other factor without departing from a true spirit and scope of the present disclosure.

### (1) Summary of Power Converter According to Embodiment

A power converter A1 according to the embodiment may be suitable for an on-board charger and auxiliary equipment power unit. The on-board charger is one for charging a main battery of an electric car with power from a power grid (a commercial AC power supply having an effective value of 100V or 200V), for example. The auxiliary equipment power unit is one for charging an auxiliary battery for driving various auxiliary equipment installed in an electric car and supplying power to the auxiliary equipment. The electric car in the embodiment includes what is called a plug-in hybrid electric car.

The power converter A1 according to the embodiment (hereinafter, referred to as a “power converter A1”) is configured to convert AC power supplied from a power grid into DC power and charge the main battery of an electric car with the DC power. In addition, the power converter A1 is configured to convert DC power outputted from the main battery of the electric car into AC power and supplies the AC power to devices out of the electric car, e.g., a low-voltage power distribution facility in ordinary households.

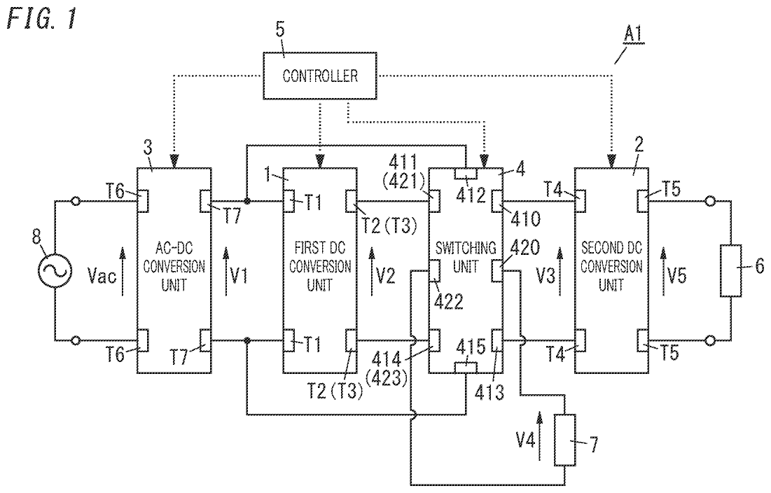

The power converter A1 includes, as shown in FIG. 1, an insulated DC conversion unit (a first DC conversion unit 1). The first DC conversion unit 1 can bidirectionally convert first DC voltage V1 into second DC voltage V2 lower than the first DC voltage V1 and vise versa.

The first DC conversion unit 1 is configured to selectively perform a first operation, a second operation, and a third operation. In the first operation, the first DC voltage V1 is converted into the second DC voltage V2. In the second operation, the second DC voltage V2 is converted into the first DC voltage V1. In the third operation, third DC voltage V3 equal to or lower than the second DC voltage V2 is converted into fourth DC voltage V4 lower than the third DC voltage V3.

Here, the first DC voltage V1 is one that has been converted from AC voltage supplied from an AC source 8, and is generally higher than the peak value of the AC voltage. The second DC voltage V2 is one lower than the first DC voltage V1, and is higher than voltage necessary for charging the main battery 6 of an electric car. The fourth DC voltage V4 has a value necessary for the operation (charging) of the low-voltage load 7 including an auxiliary battery and auxiliary equipment of an electric car.

The power converter A1 allows the DC conversion unit (the first DC conversion unit 1) to selectively output the second DC voltage V2 and the fourth DC voltage V4, so that the power converter A1 can have a reduced overall size compared to a configuration where the second DC voltage V2 and the fourth DC voltage V4 are outputted from separate DC conversion units. In addition, the DC conversion unit (the first DC conversion unit 1) of the power converter A1 is bidirectional and insulated-type, so that it is electrically insulated from the low-voltage load 7, thereby enhancing safety compared to the conventional technique.

### (2) Details of Power Converter

### (2-1) Configuration of Power Converter

The power converter A1 includes, as shown in FIG. 1, the first DC conversion unit 1. The power converter A1 further includes a second DC conversion unit 2, an AC-DC conversion unit 3, a switching unit 4, and a controller 5. Note that in the following description, the phrase “be connected” and “to be connected” refer herein to “be electrically connected” and “to be electrically connected”, respectively.

The AC-DC conversion unit 3 includes a pair of sixth terminals T6 and a pair of seventh terminals T7. The first DC conversion unit 1 includes a pair of first terminals T1, a pair of second terminals T2, and a pair of third terminals T3. The pair of second terminals T2 and the pair of third terminals T3 are connected to each other one by one. The second DC conversion unit 2 includes a pair of fourth terminals T4 and a pair of fifth terminals T5.

The pair of sixth terminals T6 of the AC-DC conversion unit 3 are to be connected to a charging inlet in the electric car. The charging inlet is to be connected to a charging cable of a charging facility or a charging and discharging cable of a charging and discharging facility. Finally, the pair of sixth terminals T6 are to be connected to the AC source 8. The pair of seventh terminals T7 of the AC-DC conversion unit 3 are connected to the pair of first terminals T1 of the first DC conversion unit 1 one by one.

The pair of second terminals T2 of the first DC conversion unit 1 are connected, via the switching unit 4, to the pair of fourth terminals T4 of the second DC conversion unit 2 one by one. The pair of third terminals T3 of the first DC conversion unit 1 are to be connected to the low-voltage load 7 via the switching unit 4.

The pair of fifth terminals T5 of the second DC conversion unit 2 are to be connected to the main battery 6 of the electric car. Note that the pair of fifth terminals T5 may be connected to both the main battery 6 and a high-voltage load other than the main battery 6.

Note that in the embodiment, all of the terminals including the first terminals T1 to the seventh terminals T7 are formed in the shape of a land on a print circuit board or contacts of connecters mounted on a print circuit substrate.

### (2-2) Circuit Configuration of First DC Conversion Unit

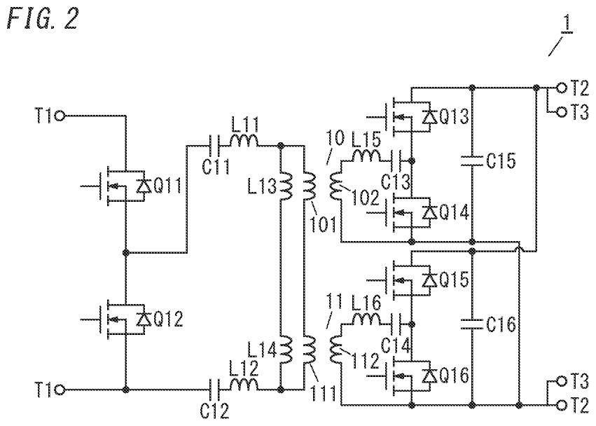

With reference to the circuit diagram in FIG. 2, the circuit configuration of the first DC conversion unit 1 will be described. The first DC conversion unit 1 include two what is called bidirectional CLLC converters.

The first DC conversion unit 1 includes six semiconductor switches Q11 to Q16, two transformers (a first transformer 10 and a second transformer 11), a plurality of inductors L11 to L16, and a plurality of capacitors C11 to C16. The six semiconductor switches Q11 to Q16 are enhancement-type N-channel Metal Oxide Semiconductor Field Effect Transistors (MOSFETs). Each of the semiconductor switches Q11 to Q16 includes a body diode between its source and drain. However, the semiconductor switch Q11 to Q16 may be a combination of a diode and a power semiconductor device other than MOSFET, such as an Insulated Gate Bipolar Transistor (IGBT), GaN, and SiC.

The semiconductor switch Q11 has its drain connected to a first terminal T1 of a positive electrode, and the semiconductor switch Q12 has its source connected to a first terminal T1 of a negative electrode. The semiconductor switch Q11 has its source and the semiconductor switch Q12 has its drain, both of which are connected to a first terminal of a capacitor C11, and the semiconductor switch Q12 has its source connected to a first terminal of the capacitor C12.

The capacitor C11 has its second terminal connected to a first terminal of the inductor L11, and the capacitor C12 has its second terminal connected to a first terminal of the inductor L12. The inductor L11 has its second terminal connected to a first terminal of the inductor L13 and a first terminal of a primary winding 101 of the first transformer 10. The inductor L12 has its second terminal connected to a first terminal of the inductor L14 and a first terminal of a primary winding 111 of the second transformer 11. The inductor L13 has its second terminal connected to a second terminal of the inductor L14. The primary winding 101 of the first transformer 10 has its second terminal connected to a second terminal of the primary winding 111 of the second transformer 11. Preferably, the two inductors L11, L13 may be made of leakage inductance and excitation inductance of the first transformer 10, respectively. Similarly, the two inductors L12, L14 may preferably be made of leakage inductance and excitation inductance of the second transformer 11, respectively.

The first transformer 10 has a secondary winding 102, which has its first terminal connected to a first terminal of the inductor L15, and the second transformer 11 has a secondary winding 112, which has its first terminal connected to a first terminal of the inductor L16. The secondary winding 102 of the first transformer 10 has its second terminal connected to the source of the semiconductor switch Q14, a second terminal of the capacitor C15, and the second terminal T2 of the negative electrode. The secondary winding 112 of the second transformer 11 has its second terminal connected to the source of the semiconductor switch Q16, a second terminal of the capacitor C16 and the second terminal T2 of the negative electrode.

The inductor L15 has its second terminal connected to a first terminal of the capacitor C13, and the inductor L16 has its second terminal connected to a first terminal of the capacitor C14. The capacitor C13 has its second terminal connected to the source of the semiconductor switch Q13 and the drain of the semiconductor switch Q14. The capacitor C14 has its second terminal connected to the source of the semiconductor switch Q15 and the drain of the semiconductor switch Q16.

The semiconductor switch Q13 has its drain electrically connected to a first terminal of the capacitor C15 and a second terminal T2 of a positive electrode. The semiconductor switch Q15 has its drain electrically connected to a first terminal of the capacitor C16 and another second terminal T2 of a positive electrode. Note that the second terminal T2 of the positive electrode is connected to a third terminal T3 of a positive electrode, and the second terminal T2 of the negative electrode is connected to a third terminal T3 of a negative electrode. Note, however, that the inductor L15 may be suitably made of leakage inductance of the first transformer 10. Similarly, the inductor L16 may be suitably made of leakage inductance of the second transformer 11.

Here, the ratio between the total number of turns N11 of the primary winding 101 of the first transformer 10 and the primary winding 11I of the second transformer 11, which are connected to each other in series, and the number of turns N12 of each of the secondary winding 102 of the first transformer 10 and the secondary winding 112 of the second transformer 11 is set to 2:1 (N11:N12=2:1). In other words, the first DC conversion unit 1 can selectively perform a step-down operation in which the DC voltage inputted into the a pair of first terminals T1 is stepped down to a DC voltage having about a half of the voltage value of the inputted DC voltage, and a step-up operation in which the DC voltage inputted into the pair of second terminals T2 is stepped up to a DC voltage having about twice as large as the voltage value of the inputted DC voltage.

Here, the first DC conversion unit 1 according to the embodiment includes a plurality of transformers (the first transformer 10 and the second transformer 11). The first transformer 10 and the second transformer 11 respectively have the secondary windings 102, 112 connected to the pair of second terminals T2 in parallel.

The first DC conversion unit 1, having a plurality of transformers, makes it possible to increase the current-carrying capacity, which can be applied to the load, compared to one having a singular transformer. However, the first DC conversion unit 1 does not have to have a plurality of transformers. Alternatively, the first DC conversion unit 1 may have just one transformer.

### (2-3) Circuit Configuration of Second DC Conversion Unit

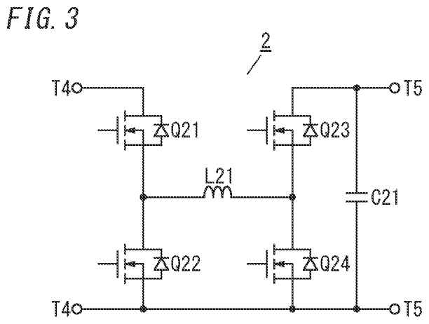

With Reference to the Circuit Diagram in FIG. 3, the Circuit Configuration of the Second DC Conversion Unit 2 Will be Described.

The second DC conversion unit 2 includes two arm pairs, and an inductor L21 that connects midpoint terminals of the two arm pairs with each other. The second DC conversion unit 2 further includes a capacitor C21 connected to one of the arm pairs in parallel.

The two arm pairs each have an arm including bidirectionally conductible semiconductor switches Q21 and Q22, or Q23, and Q24. Note that each of these four semiconductor switches Q21 to Q24 is an enhancement-type N-channel MOSFET, and has a body diode between its source and drain. Alternatively, each of the semiconductor switches Q21 to Q24 may be a combination of a diode and a power semiconductor device other than MOSFET, such as IGBT, GaN, and SiC.

One of the arm pairs includes the two semiconductor switches Q21, Q22, the other of arm pairs includes the two semiconductor switches Q23, Q24.

The semiconductor switch Q21 has its drain connected to a fourth terminal T4 of a positive electrode, and the semiconductor switch Q22 has its source connected to a fourth terminal T4 of a negative electrode. The connection node (a midpoint terminal of the arm pair), which connects the source of the semiconductor switch Q21 to the drain of semiconductor switch Q22, is connected to a first terminal of the inductor L21.

The semiconductor switch Q23 has its drain connected to a first terminal of the capacitor C21 and a fifth terminal T5 of a positive electrode. The semiconductor switch Q24 has its source connected to the source of the semiconductor switch Q22, a second terminal of the capacitor C21, and a fifth terminal T5 of a negative electrode. The connection node (a midpoint terminal of the arm pair), which connects the source of the semiconductor switch Q23 to the drain of the semiconductor switch Q24, is connected to a second terminal of the inductor L21.

### (2-4) Circuit Configuration of AC-DC Conversion Unit

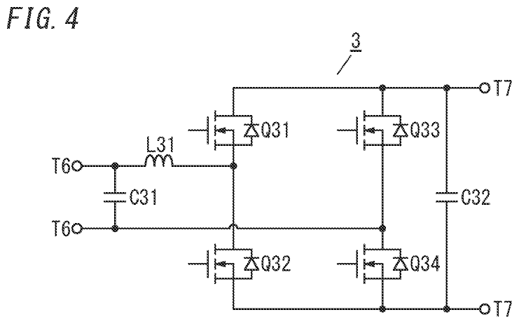

With reference to a circuit diagram in FIG. 4, the circuit configuration of the AC-DC conversion unit 3 will be described.

The AC-DC conversion unit 3 includes four semiconductor switches Q31, Q32, Q33, Q34, an inductor L31, and two capacitors C31, C32. Each of the four semiconductor switches Q31 to Q34 is an enhancement-type N-channel MOSFET, and includes a body diode between its source and drain. However, each of the semiconductor switches Q31 to Q34 may be a combination of a diode and a power semiconductor device other than MOSFET, such as IGBT, GaN, and SiC.

The semiconductor switch Q31 has its source connected to the drain of the semiconductor switch Q32 and a second terminal of inductor L31. The semiconductor switch Q31 has its drain connected to the drain of the semiconductor switch Q33, a first terminal of the capacitor C32, and a seventh terminal T7 of a positive electrode. The semiconductor switch Q32 has its source connected to the source of the semiconductor switch Q34, a second terminal of the capacitor C32, and a seventh terminal T7 of a negative electrode.

The inductor L31 has its first terminal connected to a sixth terminal T6 of a positive electrode and a first terminal of the capacitor C31. The capacitor C31 has its second terminal connected to a sixth terminal T6 of a negative electrode, the source of the semiconductor switch Q33, and the drain of the semiconductor switch Q34.

### (2-5) Circuit Configuration of Switching Unit

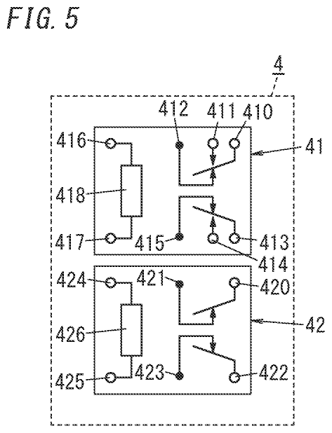

With reference to a circuit diagram in FIG. 5, the circuit configuration of the switching unit 4 will be described.

The switching unit 4 includes a first switching unit 41 and a second switching unit 42. The first switching unit 41 may be configured by, for example, a single-stable type electromagnetic relay having two changeover contact points (switching contacts). The second switching unit 42 may be configured by a single-stable type electromagnetic relay having two break contact points (normally-closed contact points). Note that the first switching unit 41 and the second switching unit 42 does not have to be an electromagnetic relay, but may be configured by, for example, a solid-state relay or a semiconductor switch.

The first switching unit 41 includes two common terminals 410, 413, two normally-open terminals 411, 414, two normally-closed terminals 412, 415, a pair of control terminals 416, 417, and an excitation coil 418. The excitation coil 418 is excited with the excitation current when the control voltage is applied to between the pair of control terminals 416, 417.

While the excitation coil 418 is not being excited, the normally-closed terminal 412 is electrically conductive with the common terminal 410 and the normally-closed terminal 415 is electrically conductive with the common terminal 413. In contrast, while the excitation coil 418 is being excited, the normally-open terminal 411 is electrically conductive with the common terminal 410, and the normally-open terminal 414 is electrically conductive with the common terminal 413.

As shown in FIG. 1, the common terminal 410 is connected to the fourth terminal T4 of the positive electrode of the second DC conversion unit 2, and the common terminal 413 is connected to the fourth terminal T4 of the negative electrode of the second DC conversion unit 2. The normally-open terminal 411 is connected to the second terminal T2 of the positive electrode of the first DC conversion unit 1 and the third terminal T3 of the positive electrode of the first DC conversion unit 1. The normally-open terminal 414 is connected to the second terminal T2 of the negative electrode and the third terminal T3 of the negative electrode of the first DC conversion unit 1. The normally-closed terminal 412 is connected to the first terminal T1 of the positive electrode of the first DC conversion unit 1, and the normally-closed terminal 415 is connected to the first terminal T1 of the negative electrode of the first DC conversion unit 1.

The second switching unit 42 includes two common terminals 420, 422, two normally-closed terminals 421, 423, a pair of control terminals 424, 425, and an excitation coil 426 (refer to FIG. 5). The excitation coil 426 is excited when a control voltage is applied to the pair of control terminals 424, 425 and an excitation current flows through the excitation coil 426.

While the excitation coil 426 is not being excited, the common terminal 420 is electrically conductive with the normally-closed terminal 421, and the common terminal 422 is electrically conductive with the normally-closed terminal 423. In contrast, while the excitation coil 426 is being excited, the common terminal 420 is not electrically conductive with the normally-closed terminal 421, and the common terminal 422 is not electrically conductive with the normally-closed terminal 423.

As shown in FIG. 1, the normally-closed terminal 421 is connected to the third terminal T3 of the positive electrode of the first DC conversion unit 1. The normally-closed terminal 423 is connected to the third terminal T3 of the negative electrode of the first DC conversion unit 1. The common terminal 420 is connected to a positive electrode of the low-voltage load 7. The common terminal 422 is connected to a negative electrode of the low-voltage load 7.

The first switching unit 41 selectively switches between a first connection state and a second connection state. The first connection state is a state where the fourth terminals T4 of the second DC conversion unit 2 are connected to the second terminals T2 of the first DC conversion unit 1. The second connection state is a state where the fourth terminals T4 of the second DC conversion unit 2 are connected to the first terminals T1 of the first DC conversion unit 1.

In contrast, the second switching unit 42 selectively switches between a state where the third terminals T3 (the second terminals T2) of the first DC conversion unit 1 are connected to the low-voltage load 7 and a state where the third terminals T3 (the second terminals T2) of the first DC conversion unit 1 are disconnected from the low-voltage load 7.

Note that the switching operations of the first switching unit 41 and the second switching unit 42 are controlled by the controller 5.

### (2-6) Configuration of Controller

The controller 5 may be implemented, for example, as an Electronic Control Unit (ECU) installed in an electric car. The ECU may include a microcomputer, a memory storing various programs, and peripheral devices such as a communications module.

The controller 5 has functions to communicate with a charging and discharging facility and a charging facility such as a charging stand via the communications lines. Note that the communications lines are suitably contained in charging and discharging cables. The charging and discharging cables are made of multicore electric cables, and function as a supply path of the charging power from the charging and discharging facility to the electric car, and a supply path of the discharging power from the electric car to the charging and discharging facility.

The controller 5 is configured to perform control in accordance with instructions from charging and discharging facility by communicating with the charging and discharging facility via the communications lines. Note that the detailed operation of the controller 5 will be described later.

### (3) Operation of Power Converter

### (3-1) Operation of First DC Conversion Unit

The first DC conversion unit 1 selectively performs a forward operation (step-down operation) and a reverse operation (step-up operation). In the forward operation, the first DC conversion unit 1 steps down the input voltage of the first terminals T1 and outputs it from the second terminals T2. In the reverse operation, the first DC conversion unit 1 steps up the input voltage, which is inputted to the second terminals T2, and output it from the first terminals T1. However, the operation of the bidirectional CLLC converter in the first DC conversion unit 1 is well-known in the art, and therefore, a detailed description thereof will be omitted herein.

In the following description, the forward operation (the step-down operation) of the first DC conversion unit 1 may be referred to as a “first operation” or a “third operation,” and the reverse operation (step-up operation) of the first DC conversion unit 1 may be referred to as a “second operation.”

### (3-2) Operation of Second DC Conversion Unit

The second DC conversion unit 2 can perform the step-up operation, the step-down operation, and a bidirectional step-up/down operation, i.e., in a forward direction (a direction along which power is transmitted from the fourth terminals T4 to the fifth terminals T5) and a reverse direction (a direction along which power is transmitted from the fifth terminals T5 to the fourth terminals T4).

For example, in the forward step-down operation, the semiconductor switch Q24 is kept to an OFF state, the semiconductor switch Q23 is kept to an ON state, and the two semiconductor switches Q21, Q22 are turned ON and OFF (switching). In the reverse step-up operation, the semiconductor switch Q23 is kept to the ON state, the semiconductor switch Q24 is kept to the OFF state, and the two semiconductor switches Q21, Q22 are turned ON and OFF (switching). In the reverse step-down operation, the semiconductor switch Q21 is kept to the ON state, the semiconductor switch Q22 is kept to the OFF state, and the two semiconductor switches Q23, Q24 are turned ON and OFF (switching). However, the operation of the bidirectional converter in the second DC conversion unit 2 is well-known in the art, and therefore, a detailed description thereof will be omitted herein.

In the following description, the forward step-down operation of the second DC conversion unit 2 may be referred to as a “fourth operation,” and the reverse step-up operation may be referred to as a “fifth operation,” and the reverse step-down operation may be referred to as a “sixth operation.”

### (3-3) Operation of AC-DC Conversion Unit

The AC-DC conversion unit 3 selectively performs a forward operation (conversion operation from AC to DC) and a reverse operation (conversion operation from DC to AC). During the forward operation, in the AC-DC conversion unit 3, the semiconductor switches Q31, Q33, and Q34 are kept to the OFF state, and the semiconductor switch Q32 is turned ON and OFF (switching). In other words, The AC-DC conversion unit 3 performing the forward operation functions as a step-up chopper for power factor correction.

In the reverse operation of the AC-DC conversion unit 3, a set of the two semiconductor switches Q31, Q34 and a set of the two semiconductor switches Q32, Q33 are turned ON and OFF (switching) alternately or complementarily. In other words, during the reverse operation, the AC-DC conversion unit 3 functions as an inverter. However, the forward and reverse operations of the AC-DC conversion unit 3 are well-known in the art, and a detailed description thereof will be omitted herein.

In the following description, the forward operation of the AC-DC conversion unit 3 may be referred to as a “seventh operation,” and the reverse operation may be referred to as an “eighth operation.”

### (3-4) Operation of Controller

The controller 5 is configured to control the first DC conversion unit 1, the second DC conversion unit 2, the AC-DC conversion unit 3, and the switching unit 4 to selectively perform three kinds of operation: a charging operation; a discharging operation; and an operation of powering the load.

### (3-4-1) Charging Operation

The charging operation refers to an operation in which the AC power supplied from the AC source 8 (refer to FIG. 1) via the charging and discharging facility (not shown) or charging facility (not shown) is converted into DC power to charge the main battery 6 with the DC power.

First, the controller 5 controls the switching unit 4 to turn the first switching unit 41 into the first connection state and turn the second switching unit 42 into a state where the third terminals T3 (the second terminals T2) of the first DC conversion unit 1 are disconnected from the low-voltage load 7.

Next, the controller 5 causes the AC-DC conversion unit 3 to perform the seventh operation in which the AC voltage Vac inputted from the AC source 8 is converted into the first DC voltage V1 that is sufficiently higher than the peak value of the AC voltage Vac. In the embodiment, the AC voltage Vac may be, for example, AC voltage having an effective voltage of 90 V-265 V with a frequency of 50 Hz or 60 Hz. The voltage value of the first DC voltage V1 may be, for example, 840 V. Note, however, that the voltage value of the first DC voltage V1 is not limited to 840 V, but may be lower than 840 V or higher than 840 V.

Furthermore, the controller 5 causes the first DC conversion unit 1 to perform the first operation in which the first DC voltage V1 that has been outputted from the AC-DC conversion unit 3 is converted into the second DC voltage V2 lower than the first DC voltage V1. In the embodiment, the voltage value of the second DC voltage V2 may be, for example, one half of the voltage value of the first DC voltage V1, i.e., 420 V. Note that the voltage value of the second DC voltage V2 is not limited to 420 V, but may be lower than 420 V or higher than 420 V.

Finally, the controller 5 causes the second DC conversion unit 2 to perform the fourth operation in which the second DC voltage V2 that has been outputted from the first DC conversion unit 1 is converted into the fifth DC voltage V5 lower than the second DC voltage V2. Note that the voltage value of the fifth DC voltage V5 refers to a voltage value necessary for charging the main battery 6, e.g., 250 V-420 V.

Then, the main battery 6 are charged with the fifth DC voltage V5 outputted from the second DC conversion unit 2.

### (3-4-2) Discharging Operation

The discharging operation refers to an operation in which DC power discharged from the main battery 6 is converted into AC power and the AC power is supplied to a charging and discharging facility (not shown).

First, the controller 5 controls the switching unit 4 to turn the first switching unit 41 into the first connection state and turn the second switching unit 42 into a state where the third terminals T3 (the second terminals T2) of the first DC conversion unit 1 are disconnected from the low-voltage load 7.

Next, the controller 5 causes the second DC conversion unit 2 to perform the fifth operation in which the DC voltage (the fifth DC voltage V5) that has been outputted from the main battery 6 is converted into the second DC voltage V2.

Next, the controller 5 causes the first DC conversion unit 1 to perform the second operation in which the second DC voltage V2 that has been outputted from the second DC conversion unit 2 is converted into the first DC voltage V1.

Finally, the controller 5 causes the AC-DC conversion unit 3 to perform the eighth operation in which the first DC voltage V1 that has been supplied from the first DC conversion unit 1 is converted into the AC voltage Vac.

Then, the AC power outputted from the power converter A1 is supplied, via the charging and discharging facility, to a low-voltage power distribution facility in ordinary households.

### (3-4-3) Operation of Powering Load

The operation of powering the load refers to an operation of stepping down DC voltage (the fifth DC voltage V5) of the DC power discharged from the main battery 6, and supplying the stepped-down DC power (power feeding) to the low-voltage load 7.

First, the controller 5 controls the switching unit 4 to turn the first switching unit 41 into the second connection state and turn the second switching unit 42 into a state where the third terminals T3 (the second terminals T2) of the first DC conversion unit 1 are connected to the low-voltage load 7.

Next, the controller 5 causes the second DC conversion unit 2 to perform the sixth operation in which the DC voltage (the fifth DC voltage V5) that has been outputted from the main battery 6 is converted into the third DC voltage V3 lower than the fifth DC voltage V5. In the embodiment, a voltage value of the third DC voltage V3 is 96 V, for example. Note that the voltage value of the third DC voltage V3 is not limited to 96 V, but may be lower than 96 V or higher than 96 V.

Next, the third DC voltage V3 that has been outputted from the second DC conversion unit 2 is inputted, via the switching unit 4, to the first terminals T1 of the first DC conversion unit 1.

Finally, the controller 5 causes the first DC conversion unit 1 to perform the third operation in which the third DC voltage V3 outputted from the second DC conversion unit 2 is converted into the fourth DC voltage V4 lower than the third DC voltage V3. In the embodiment, the voltage value of the fourth DC voltage V4 refers to a voltage value necessary for the operation of the low-voltage load 7, e.g., 48 V. Note, however, that voltage value of the fourth DC voltage V4 is not limited to 48 V, but may be lower than 48 V or higher than 48 V.

Then, the low-voltage load 7 operates based on the fourth DC voltage V4 supplied from the first DC conversion unit 1 via the switching unit 4. For example, if the low-voltage load 7 contains an auxiliary battery, the auxiliary battery will be charged by the fourth DC voltage V4.

### (3-4-4) Switching of Operations by Controller

The controller 5 switches, depending on the following conditions, between three kinds of operation: a charging operation; a discharging operation; and an operation of powering the load.

If the electric car is connected to the charging facility via a charging cable, the controller 5 will perform the charging operation. However, if the main battery 6 have been fully charged, the controller 5 will not perform the charging operation. The controller 5 detects whether or not its connection with the charging facility by making communications with communication lines contained in the charging cable. After detecting the connection with the charging facility, the controller 5 receives the charging start permittance from the charging facility via the communications line, and then start the charging operation.

If the electric car is connected to the charging and discharging facility via a charging and discharging cable, the controller 5 performs the charging operation or the discharging operation. The controller 5 detects its connection to the charging and discharging facility by communicating with the charging and discharging facility via communication lines contained in the charging and discharging cable. After detecting the connection with the charging and discharging facility, the controller 5 receives a charging start permission from the charging and discharging facility via the communications lines, and then starts the charging operation. The controller 5 receives a request for starting the discharge from the charging and discharging facility via the communications lines, and then starts the discharging operation.

If the electric car is neither connected to the charging and discharging facility nor the charging facility, e.g., the electric car is traveling or stopping, the controller 5 performs an operation of powering the load according to situations (battery level of the auxiliary battery, for example) of the low-voltage load 7. For example, the controller 5 measures battery voltage of the auxiliary battery, and performs an operation of powering the load such that battery voltage of the auxiliary battery will not go out of (i.e., not lower than) a certain range.

Additionally or alternatively, the controller 5 may switch the operations among the charging operation, the discharging operation, and the operation of powering the load, depending on the presence or absence of the input of the AC voltage Vac to the AC-DC conversion unit 3. In other words, the controller 5 can also control each of the AC-DC conversion unit 3, the first DC conversion unit 1, the second DC conversion unit 2, and the switching unit 4, depending on the presence or absence of the input of the AC voltage Vac to the AC-DC conversion unit 3. For example, when the electric car is connected to the charging cables or the charging and discharging cables, the AC voltage Vac is applied to the sixth terminals T6 of the AC-DC conversion unit 3. The controller 5 can detect the applied voltage to the sixth terminals T6 to determine the presence or absence of the input of the AC voltage Vac, and then switches the operations among the charging operation, the discharging operation, and the operation of powering the load.

### (4) Variations

In the aforementioned power converter A1, the first DC conversion unit 1 may have a full-bridge type bidirectional CLLC converter instead of a half-bridge type bidirectional CLLC converter. The first DC conversion unit 1 may include an insulated bidirectional converter such as a Dual Active Bridge (DAB)-type bidirectional insulated converter, a push-pull bidirectional converter, a bidirectional insulated Cuk converter, and a bidirectional insulation-type SEPIC ZETA converter, instead of the bidirectional CLLC converter.

The first switching unit 41 and the second switching unit 42 of the switching unit 4 may be made of a semiconductor device such as a solid-state relay, instead of the electromagnetic relay.

Part or all of magnetic components configuring the power converter A1, such as the inductors L11 to L16, L21, and L31, the first transformer 10, and the second transformer 11, may be configured by conductors printed on a print circuit substrate. In that case, the power converter A1 can reduce the height of the print circuit configuring the first DC conversion unit 1, the second DC conversion unit 2, and the AC-DC conversion unit 3 because the conductors printed on the print circuit substrate forms the magnetic components, thus allowing the power converter A1 to have a reduced height and overall size.

### (5) Advantages of Power Converter According to Embodiment

The selective performance of the first to third operations by the first DC conversion unit 1 of the power converter A1 makes unnecessary a dedicated circuit for performing the third operation. Therefore, the power converter A1 may be reduced in size compared to a case where a dedicated circuit for the third operation is provided. In addition, the insulated converter of the first DC conversion unit 1 prevents the fourth DC voltage V4 from rising abnormally, thus enhancing safety.

Furthermore, the selective performance of the fourth to sixth operations by the second DC conversion unit 2 of the power converter A1 makes unnecessary a dedicated circuit for performing the sixth operation. Therefore, the power converter A1 can be reduced in size compared to a case where a dedicated circuit for performing the sixth operation is provided, thus allowing the power converter A1 to have a more reduced overall size.

In addition, the power converter A1 inputs the third DC voltage V3 that has been outputted from the second DC conversion unit 2 to the first terminals T1 of the first DC conversion unit 1 via the switching unit 4, and coverts it into the fourth DC voltage V4 by the forward step-down operation (third operation) of the first DC conversion unit 1. That is, the third operation of the first DC conversion unit 1 is substantially the same operation as the first operation of the first DC conversion unit 1, except that a voltage value of the input voltage and a voltage value of the output voltage are different between the first operation and the third operation.

The power converter A1 can step down the third DC voltage V3 to the fourth DC voltage V4 and supply it to the low-voltage load 7, without dynamically switching turns ratio of the transformers (the first transformer 10 and the second transformer 11) of the first DC conversion unit 1, thus allowing the power converter A1 to have a more reduced overall size.

### (6) Resume

A power converter (A1) according to a first aspect of the present disclosure includes an insulated DC conversion unit (the first DC conversion unit 1) that is configured to bidirectionally covert a first DC voltage (V1) into a second DC voltage (V2) lower than the first DC voltage (V1) and vise versa. The DC conversion unit is configured to selectively perform a first operation, a second operation, and a third operation. The first operation converts the first DC voltage (V1) into the second DC voltage (V2). The second operation converts the second DC voltage (V2) into the first DC voltage (V1). The third operation converts a third DC voltage (V3) that is equal to or lower than the second DC voltage (V2) into a fourth voltage (V4) that is lower than the third DC voltage (V3).

The power converter (A1) according to the first aspect can be reduced in size compared to a case where a dedicated circuit for performing the third operation is provided. In addition, the insulated DC conversion unit of the power converter (A1) according to the first aspect prevents the fourth DC voltage (V4) from rising abnormally, thus enhancing safety.

The power converter (A1) according to a second aspect of the present disclosure may be implemented in combination with the first aspect. In the power converter (A1) according to the second aspect, the DC conversion unit suitably includes a bidirectional CLLC converter.

The power converter (A1) according to the second aspect simplifies the circuit configuration, thus allowing the power converter (A1) to have a more reduced overall size.

The power converter (A1) according to a third aspect of the present disclosure may be implemented in combination with the first or second aspect. In the power converter (A1) according to the third aspect, the DC conversion unit is suitably a first DC conversion unit (1). The power converter suitably further comprises a second DC conversion unit (2). The second DC conversion unit (2) is suitably configured to bidirectionally convert the second DC voltage (V2) into a fifth DC voltage (V5) that is lower than the second DC voltage (V2) and higher than the third DC voltage (V3) and vise versa. The second DC conversion unit (2) is suitably configured to convert the fifth DC voltage (V5) into the third DC voltage (V3). The second DC conversion unit (2) is suitably configured to selectively perform a fourth operation, a fifth operation, and a sixth operation. The fourth operation converts the second DC voltage (V2) into the fifth DC voltage (V5). The fifth operation, the fifth DC voltage (V5) converts the fifth DC voltage (V5) into the second DC voltage (V2). The sixth operation converts the fifth DC voltage (V5) into the third DC voltage (V3).

The power converter (A1) according to the third aspect makes unnecessary a dedicated circuit for performing the sixth operation, compared to a case where a dedicated circuit for performing the sixth operation is provided, thus allowing the power converter (A1) to have a more reduced overall size.

The power converter (A1) according to a fourth aspect of the present disclosure may be implemented in combination with the third aspect. In the power converter (A1) according to the fourth aspect, the second DC conversion unit (2) suitably includes two arm pairs (the semiconductor switches Q21, Q22, and the semiconductor switches Q23, Q24), and an inductor (L21) that connects midpoint terminals of the two arm pairs with each other. Each of the two arm pairs suitably includes an arm including a semiconductor switch (Q21, Q22, Q23, Q24) that is electrically conductible bidirectionally.

The power converter (A1) according to the fourth aspect simplifies the circuit configuration of the second DC conversion unit (2) thus allowing the power converter (A1) to have a more reduced overall size.

The power converter (A1) according to a fifth aspect of the present disclosure may be implemented in combination with the third or fourth aspect. In the power converter (A1) according to the fifth aspect, the first DC conversion unit (1) suitably includes: a first terminal (T1) to and from which the first DC voltage (V1) is inputted and outputted; a second terminal (T2) from and to which the second DC voltage (V2) is outputted and inputted; and a third terminal (T3) from which the fourth DC voltage (V4) is outputted. The second DC conversion unit (2) suitably includes: a fourth terminal (T4) to and from which the second DC voltage (V2) is inputted and outputted, and from which the third DC voltage (V3) is outputted; and a fifth terminal (T5) from and to which the fifth DC voltage (V5) is outputted and inputted. The power converter (A1) according to the fifth aspect suitably further comprises a switching unit (4). The switching unit (4) is configured to selectively switch between a first connection state where the fourth terminal (T4) is connected to the second terminal (T2) and a second connection state where the fourth terminal (T4) is connected to the first terminal (T1). The first DC conversion unit (1) is suitably configured to selectively perform, in the first connection state, the first operation and the second operation. The second DC conversion unit (2) is suitably configured to selectively perform, in the first connection state, the fourth operation and the fifth operation. The second DC conversion unit (2) is suitably configured to selectively perform, in the first connection state, the fourth operation and the fifth operation. The second DC conversion unit (2) is suitably configured to perform, in the second connection state, the sixth operation. The first DC conversion unit (1) is suitably configured to perform, in the second connection state, the third operation.

The power converter (A1) according to the fifth aspect can input the third DC voltage (V3) that has been outputted from the second DC conversion unit (2) to the first terminal (T1) of the first DC conversion unit (1) via the switching unit (4), and convert it into the fourth DC voltage (V4) by the third operation of the first DC conversion unit (1). As a result, the power converter (A1) according to the fifth aspect can convert, without dynamically switching ratios of voltage conversion in the first DC conversion unit (1), the third DC voltage (V3) into the fourth DC voltage (V4), thus allowing the power converter (A1) to have a more reduced overall size.

The power converter (A1) according to a sixth aspect of the present disclosure may be implemented in combination with the fifth aspect. The power converter (A1) according to the sixth aspect suitably further comprises an AC-DC conversion unit (3) that is configured to bidirectionally convert AC voltage (Vac) into a first DC voltage (V1) that is higher than a peak voltage of the AC voltage (Vac) and vise versa. The AC-DC conversion unit (3) is suitably configured to selectively perform: a seventh operation to convert the AC voltage (Vac) into the first DC voltage (V1); and an eighth operation to convert the first DC voltage (V1) into the AC voltage (Vac).

The power converter (A1) according to the sixth aspect can deal with AC input and AC output with the AC-DC conversion unit (3).

The power converter (A1) according to a seventh aspect of the present disclosure may be implemented in combination with the sixth aspect. The power converter (A1) according to the seventh aspect suitably further comprises a controller (5). In the power converter (A1) according to the seventh aspect, the controller (5) is suitably configured to control the first DC conversion unit (1) to selectively perform the first operation, the second operation, and the third operation. The controller (5) is suitably configured to control the second DC conversion unit (2) to selectively perform the fourth operation, the fifth operation, and the sixth operation. The controller (5) is suitably configured to control the AC-DC conversion unit (3) to selectively perform the seventh operation and the eighth operation. The controller (5) is suitably configured to control the switching unit (4) to selectively switch between the first connection state and the second connection state.

The power converter (A1) according to the seventh aspect can smoothly switch the operations with the controller (5) that can control, as one device, the first DC conversion unit (1), the second DC conversion unit (2), the AC-DC conversion unit (3), and switching unit (4).

The power converter (A1) according to the eighth aspect of the present disclosure may be implemented in combination with the seventh aspect. In the power converter (A1) according to the eighth aspect, the controller (5) is suitably configured to separately control, based on presence or absence of input of the AC voltage (Vac) into the AC-DC conversion unit (3), the AC-DC conversion unit (3), the first DC conversion unit (1), the second DC conversion unit (2), and the switching unit (4).

The power converter (A1) according to the eighth aspect can switch to an appropriate operation based on the presence or absence of the input of the AC voltage (Vac).

The power converter (A1) according to the ninth aspect of the present disclosure may be implemented in combination with any one of the sixth to eighth aspects. In the power converter (A1) according to the ninth aspect, the first DC conversion unit (1) suitably includes a plurality of transformers (the first transformer 10, the second transformer 11) each having a secondary winding that is connected to the second terminal (T2) in parallel.

The power converter (A1) according to the ninth aspect, in which the first DC conversion unit (1) includes a plurality of transformers, increases the output from the first DC conversion unit (1), compared to a case where the transformer is singular.

The power converter (A1) according to the tenth aspect of the present disclosure may be implemented in combination with any one of the sixth to ninth aspects. In the power converter (A1) according to the tenth aspect, the second DC conversion unit (2) is suitably configured to be connected, via the fifth terminal (T5), to a main battery (6) installed in an electric car. The AC-DC conversion unit (3) is suitably configured to be connected to a charging inlet installed in the electric car.

The power converter (A1) according to the tenth aspect, which is installed on an electric car, enables supplying power from the main battery (6) installed in the electric car to a power distribution facility in households.

### REFERENCE SIGNS LIST

A1 Power Converter
1 First DC Conversion Unit (DC Conversion Unit)
2 Second DC Conversion Unit
3 AC-DC Conversion Unit
4 Switching Unit
5 Controller
6 Main Battery
10 First Transformer
11 Second Transformer
T1 First Terminal
T2 Second Terminal
T3 Third Terminal
T4 Fourth Terminal
T5 Fifth Terminal
T6 Sixth Terminal
T7 Seventh Terminal
V1 First DC Voltage
V2 Second DC Voltage
V3 Third DC Voltage
V4 Fourth DC Voltage
V5 Fifth DC Voltage
Vac AC Voltage

1. A power converter comprising:
an insulated DC conversion unit that is configured to bidirectionally covert a first DC voltage into a second DC voltage that is lower than the first DC voltage and vise versa,
the DC conversion unit being configured to selectively perform:
a first operation to convert the first DC voltage into the second DC voltage;
a second operation to convert the second DC voltage into the first DC voltage; and
a third operation to convert a third DC voltage that is equal to or lower than the second DC voltage into a fourth voltage that is lower than the third DC voltage.

2. The power converter of claim 1, wherein the DC conversion unit includes a bidirectional CLLC converter.

3. The power converter of claim 1, wherein
the DC conversion unit is a first DC conversion unit,
the power converter further comprises a second DC conversion unit, the second DC conversion unit being configured to bidirectionally convert the second DC voltage into a fifth DC voltage that is lower than the second DC voltage and higher than the third DC voltage and vise versa, and the second DC conversion unit being configured to convert the fifth DC voltage into the third DC voltage,
the second DC conversion unit is configured to selectively perform:
a fourth operation to convert the second DC voltage into the fifth DC voltage;
a fifth operation to convert the fifth DC voltage into the second DC voltage; and
a sixth operation to convert the fifth DC voltage into the third DC voltage.

4. The power converter of claim 3, wherein
the second DC conversion unit includes:
two arm pairs; and
an inductor that connects midpoint terminals of the two arm pairs with each other, and
each of the two arm pairs includes an arm including a semiconductor switch that is electrically conductible bidirectionally.

5. The power converter of claim 3, wherein
the first DC conversion unit includes:
a first terminal to and from which the first DC voltage is inputted and outputted;
a second terminal from and to which the second DC voltage is outputted and inputted; and
a third terminal from which the fourth DC voltage is outputted,
the second DC conversion unit includes:
a fourth terminal to and from which the second DC voltage is inputted and outputted, and from which the third DC voltage is outputted; and
a fifth terminal from and to which the fifth DC voltage is outputted and inputted,
the power converter further comprises a switching unit that is configured to selectively switch between a first connection state where the fourth terminal is connected to the second terminal and a second connection state where the fourth terminal is connected to the first terminal,
the first DC conversion unit is configured to selectively perform, in the first connection state, the first operation and the second operation,
the second DC conversion unit is configured to selectively perform, in the first connection state, the fourth operation and the fifth operation,
the second DC conversion unit is configured to perform, in the second connection state, the sixth operation, and
the first DC conversion unit is configured to perform, in the second connection state, the third operation.

6. The power converter of claim 5, further comprising an AC-DC conversion unit that is configured to bidirectionally convert AC voltage into a first DC voltage that is higher than a peak voltage of the AC voltage and vise versa, wherein
the AC-DC conversion unit is configured to selectively perform:
a seventh operation to convert the AC voltage into the first DC voltage; and
an eighth operation to convert the first DC voltage into the AC voltage.

7. The power converter of claim 6, further comprising a controller, wherein the controller is configured to:
control the first DC conversion unit to selectively perform the first operation, the second operation, and the third operation;
control the second DC conversion unit to selectively perform the fourth operation, the fifth operation, and the sixth operation;
control the AC-DC conversion unit to selectively perform the seventh operation and the eighth operation; and
control the switching unit to selectively switch between the first connection state and the second connection state.

8. The power converter of claim 7, wherein the controller is configured to separately control, based on presence or absence of input of the AC voltage into the AC-DC conversion unit, the AC-DC conversion unit, the first DC conversion unit, the second DC conversion unit, and the switching unit.

9. The power converter of claim 6, wherein
the first DC conversion unit includes a plurality of transformers each having a secondary winding that is connected to the second terminal in parallel.

10. The power converter of claim 6, wherein
the second DC conversion unit is configured to be connected, via the fifth terminal, to a main battery installed in an electric car, and
the AC-DC conversion unit is configured to be connected to a charging inlet installed in the electric car.

11. The power converter of claim 2, wherein
the DC conversion unit is a first DC conversion unit,
the power converter further comprises a second DC conversion unit, the second DC conversion unit being configured to bidirectionally convert the second DC voltage into a fifth DC voltage that is lower than the second DC voltage and higher than the third DC voltage and vise versa, and the second DC conversion unit being configured to convert the fifth DC voltage into the third DC voltage,
the second DC conversion unit is configured to selectively perform:
a fourth operation to convert the second DC voltage into the fifth DC voltage;
a fifth operation to convert the fifth DC voltage into the second DC voltage; and
a sixth operation to convert the fifth DC voltage into the third DC voltage.

12. The power converter of claim 4, wherein
the first DC conversion unit includes:
a first terminal to and from which the first DC voltage is inputted and outputted;
a second terminal from and to which the second DC voltage is outputted and inputted; and
a third terminal from which the fourth DC voltage is outputted,
the second DC conversion unit includes:
a fourth terminal to and from which the second DC voltage is inputted and outputted, and from which the third DC voltage is outputted; and
a fifth terminal from and to which the fifth DC voltage is outputted and inputted,
the power converter further comprises a switching unit that is configured to selectively switch between a first connection state where the fourth terminal is connected to the second terminal and a second connection state where the fourth terminal is connected to the first terminal,
the first DC conversion unit is configured to selectively perform, in the first connection state, the first operation and the second operation,
the second DC conversion unit is configured to selectively perform, in the first connection state, the fourth operation and the fifth operation,
the second DC conversion unit is configured to perform, in the second connection state, the sixth operation, and
the first DC conversion unit is configured to perform, in the second connection state, the third operation.

13. The power converter of claim 7, wherein
the first DC conversion unit includes a plurality of transformers each having a secondary winding that is connected to the second terminal in parallel.

14. The power converter of claim 8, wherein
the first DC conversion unit includes a plurality of transformers each having a secondary winding that is connected to the second terminal in parallel.

15. The power converter of claim 7, wherein
the second DC conversion unit is configured to be connected, via the fifth terminal, to a main battery installed in an electric car, and
the AC-DC conversion unit is configured to be connected to a charging inlet installed in the electric car.

16. The power converter of claim 8, wherein
the second DC conversion unit is configured to be connected, via the fifth terminal, to a main battery installed in an electric car, and
the AC-DC conversion unit is configured to be connected to a charging inlet installed in the electric car.

17. The power converter of claim 9, wherein
the second DC conversion unit is configured to be connected, via the fifth terminal, to a main battery installed in an electric car, and
the AC-DC conversion unit is configured to be connected to a charging inlet installed in the electric car.
